(19) United States
(12) Patent Application Publication
(10) Pub. No.: US 2025/0371900 A1
(43) Pub. Date: Dec. 4, 2025

(54) METHOD AND SYSTEM FOR NEURAL NETWORK BASED DOCUMENT ACQUISITION

(71) Applicant: OPEN TEXT HOLDINGS, INC., Menlo Park, CA (US)

(72) Inventor: Sai Krishna Chaitanya Poloju, Hyderabad (IN)

(21) Appl. No.: 18/675,998

(22) Filed: May 28, 2024

(51) Int. Cl. G06V 30/414; G06V 10/82; G06V 30/413

(52) U.S. Cl. CPC G06V 30/414; G06V 10/82; G06V 30/413

(57) ABSTRACT

Systems and methods for text analysis are provided. Various embodiments of the present technology provide systems and methods for improved text analysis by providing a comprehensive robust solution that solves character-set identification and print type classification along with text detection from scene text images/documents. Systems and methods for improved text analysis integrate text detection, character-set identification, and print type classification into a unified framework.

### TECHNICAL FIELD

This disclosure relates generally to data acquisition. In particular, this disclosure relates to systems and methods relating to character set identification and print type classification using neural networks.

### BACKGROUND

Scene text detection, character set identification, and print type classification are important components in the field of document analysis and computer vision, with applications spanning from text recognition to document understanding and information retrieval. Scene text detection involves identifying and localizing textual content within images or documents. This task is beneficial for various applications, including text recognition and optical character recognition (OCR). However, scene text detection faces various challenges that can hinder accurate detection and localization.

Character set identification focuses on determining the specific character set or encoding used to represent text within a document or image. This task is beneficial for accurately interpreting and processing textual data, particularly in multilingual or multi-script contexts. Challenges in character set identification include the presence of multiple languages or scripts within the same document, ambiguous or noisy text regions, and variations in text formatting and layout.

Similarly, print type classification involves categorizing text based on various typographic features such as font type, style, size, and weight. Print type classification is beneficial for tasks like font recognition, document layout analysis, etc. However, challenges arise from the diverse and complex nature of fonts, variations in text formatting and layout, and the presence of decorative or stylized text elements.

Despite their significance, these tasks are often considered separately in traditional approaches, leading to suboptimal performance and limited scalability. Integrating scene text detection, character set identification, and print type classification into a unified framework would present opportunities to address these challenges and enhance overall document analysis capabilities, while also improving the performance of document acquisition systems.

In the field of document analysis and scene text understanding, the challenges of accurate character-set identification, print type classification, and text detection have long been regarded as distinct yet interrelated tasks. While scene text detection primarily focuses on identifying text regions within images or documents at a holistic level, character set identification and print type classification delve deeper, operating at a word or line level to discern the specific characteristics of individual textual elements. These tasks are beneficial for various applications, including optical character recognition (OCR), document indexing, information retrieval, etc. However, conventional approaches often treat these tasks in isolation, overlooking potential synergies that could enhance overall performance.

### SUMMARY

Systems and methods for text analysis are described that, in some embodiments, include receiving an image document containing textual information. Features of the image document are extracted by a backbone network and provided to a detection head, which generates a feature map based on the extracted features. The feature map is provided to a text detection module, which generates, from the feature map, a text detection map identifying localized text regions in the image document. The feature map is also provided to a CNN network. The CNN network estimates character set identification and print type classification of text on the image document based on the feature map and the text detection map.

Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of a text detection architecture.

FIG. 2 is a block diagram of a rectification module for receiving arbitrary-shaped word images and output straightened word images.

FIG. 3 is a block diagram of a character set identification architecture.

FIG. 4 is a block diagram of a print-type classification architecture.

FIG. 5 is a block diagram of a text detection architecture utilizing a backbone network, a detection head, a text detection component, a CNN network, a character set identification component, and a print type classification component.

FIG. 6 is a flow chart illustrating a process for text analysis.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

One objective of the disclosed techniques is to develop a comprehensive robust solution that targets to solve character-set identification and print type classification along with text detection from scene text images/documents. Generally, the present disclosure relates to holistic solution that integrates text detection, character-set identification, and print type classification into a unified framework. By leveraging advancements in convolutional neural networks (CNNs) and attention mechanisms, the disclosed solution addresses the challenges posed by complex document layouts, variable text sizes, diverse font styles, etc. Before describing the holistic solution mentioned above, a first example will be described where text detection, character-set identification, and print type classification are determined separately. Note that any type of neural network, machine learning device, artificial intelligence (AI), etc., may also be used, instead of a CNN.

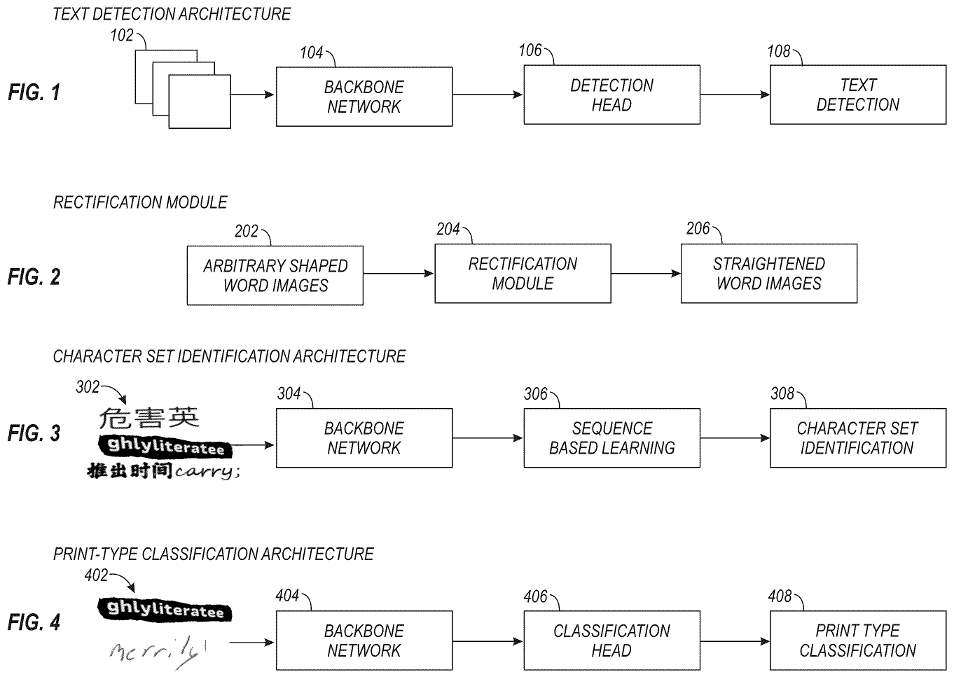

FIGS. 1-4 are block diagrams illustrating examples of architectures for determining text detection, character-set identification, and print type classification. FIG. 1 is a block diagram of a text detection architecture that utilizes a backbone network, a detection head, and text detection for analyzing input text documents 102 at a document level. The input text documents can come from any source, such as scanned documents, image documents, etc., as one skilled in the art would understand.

The text detection architecture of FIG. 1 includes of a backbone network 104 for feature extraction, a detection head 106 for generating detection predictions, and a text detection component 108 (or text detection module) for post-processing and refining the results. The architecture of FIG. 1 can effectively locate text regions within input documents, enabling downstream tasks such as optical character recognition (OCR), document analysis, and information retrieval. The backbone network 104 serves as a feature extractor for a text detection model. A backbone network typically consists of convolutional layers that extract features from an input document image. The choice of backbone network can vary based on the requirements of the task and the complexity of the input data. The detection head 106 is responsible for generating text detection predictions based on features extracted by the backbone network 104. A detection head typically consists of additional convolutional layers followed by a set of output layers that produce detection scores and bounding box coordinates for text regions. The text detection component 108 takes the detection predictions generated by the detection head 106 and post-processes them to produce the final text detection results.

FIG. 2 is a block diagram of a rectification module for receiving arbitrary-shaped word images and output straightened word images. As shown in FIG. 2, a rectification module 106 is designed to receive arbitrary-shaped word images 202 and output straightened word images typically 206. A typical rectification module includes several components to address the challenges of correcting distortions, deformations, and irregularities in the input word images, as one skilled in the art would understand. The rectification module architecture can effectively receive arbitrary-shaped word images as input and output straightened word images, enabling downstream tasks such as optical character recognition (OCR), text analysis, and document processing. The module's ability to correct distortions and align text regions enhances the accuracy and reliability of text-based applications in various domains.

FIG. 3 is a block diagram of a character set identification architecture for analyzing input text data 302 and identifying the character set or language script present in the text. In this example, the character set identification architecture includes a backbone network 304, a sequence-based learning component 306, and character set identification component 308. In some embodiments, the backbone network 304 extracts relevant features from input images (e.g., input text data 302) containing text, while the sequence-based learning component 306 captures sequential dependencies and context within the text data. Finally, the character set identification component 308 performs classifications to determine the specific character set or script, enabling applications such as multilingual OCR, language detection, and text processing.

As mentioned, the backbone network 304 serves as a feature extractor for the character set identification model of FIG. 3. A backbone network typically consists of convolutional layers that extract features from the input word or line images (such as input text data 302) containing text. Note that, in this example, the input text data 302 (as well as input data 402, discussed below) may typically comprise a relatively small image containing text of some sort, rather than comprising an entire document. The choice of backbone network can vary based on the complexity of the input data and the requirements of the task. After feature extraction, the sequence-based learning component 306 processes the extracted features to capture the sequential dependencies and contextual information inherent in the input data 302. The sequence-based learning component 306 may include neural network layers, which are suited for modeling sequential data like text. These layers enable the model to learn patterns and relationships between characters across the input text sequence. The character set identification component 308 takes the output of the sequence-based learning module 306 and performs character set classification to identify the specific character set or language script present in the input text. Examples of items that may be identified include different languages, numbers, etc. Similarly, the print-type classification (discussed below) can determine whether text is machine printed, handwritten, cursive, etc. Based on the identified characters and print type classification, proper recognition models can be selected. For example, different recognition models may be configured to work with different languages, machine type, handwritten text, etc.

FIG. 4 is a block diagram of a print-type classification architecture for analyzing input text data 402 and classifying the print type of the text. In this example, the print-type classification architecture includes a backbone network 404, a classification head 406, and a print type classification component 408. The print-type classification architecture shown in FIG. 4 can analyze input text images and classify the print type of the text. The backbone network 404 extracts relevant features from the input images containing text, while the classification head 406 processes these features to classify the print type. Finally, the print type classification component 408 performs the classification, enabling applications such as font recognition, document layout analysis, and graphic design.

As mentioned, the backbone network 404 serves as the feature extractor for the print-type classification model. A backbone network typically consists of convolutional layers that extract hierarchical features from the input images (such as input text data 302) containing text. The choice of backbone network depends on the complexity of the input data and the requirements of the task. After feature extraction, the classification head 406 processes the extracted features to classify the print type of the input text. The print type classification component 408 takes the output of the classification head 406 and performs print type classification to determine the specific print type of the text in the input images. The print type classification component 408 may involve additional post-processing steps to refine the classification results or to handle specific challenges associated with print type classification, such as variations in font type, style, size, and weight.

As mentioned above, one objective of the disclosed techniques is to develop a comprehensive solution for document acquisition that targets to solve character-set identification and print type classification along with text detection from scene text images/documents using a single model. One novelty of the disclosed techniques relates to the overall approach followed for the comprehensive solution of text detection, character-set identification and print type classification. Another novelty of the disclosed techniques relates to using a text detection probability map to calculate the loss for character-set and print type identification and penalize only the actual text regions and ignore the other parts of the image during training. One novelty of the disclosed techniques relates to using the text detection map for character-set identification and print type classification at a character level, versus the word or line level.

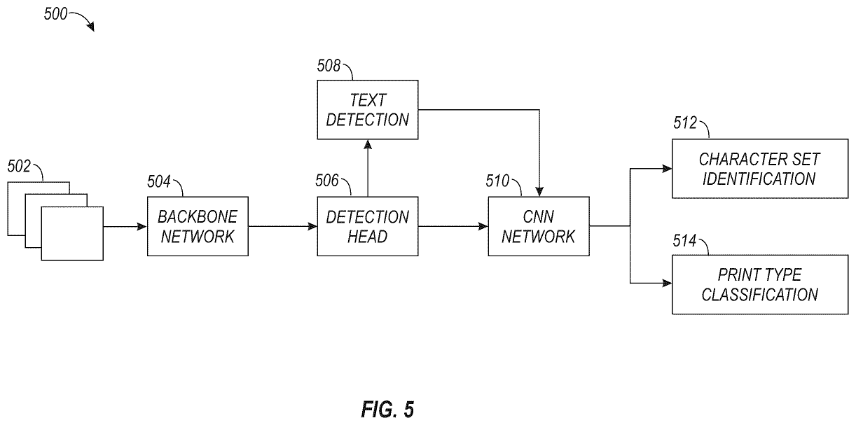

FIG. 5 is a block diagram of a text detection architecture 500 that utilizes a backbone network 504, a detection head 506, a text detection component 508, a CNN network 510, a character set identification component 512, and a print type classification component 514, each described in detail below. Note that the architecture 500 for character-set identification, print type classification, and text detection utilizes a single model, rather than separate models for each inference (e.g., such as in FIGS. 1-4), thus leveraging shared feature representations and enabling joint optimization for improved performance and efficiency.

Image documents 502 are provided as input to a ResNet-based backbone network 504, which serves as a feature extractor. The backbone network 504 extracts hierarchical features from the input images 502 to capture relevant information for subsequent tasks.

The output of the backbone network 504 is fed into a detection head component 506, which includes ROI pooling layers for text detection. This detection head 506 provides inputs to both the text detection component 508 and a CNN network 510 for character set identification and print type classification.

The text detection component 508 processes the feature maps from the detection head 506 to localize text regions within the input images 502. The text detection component 508 outputs a text detection map highlighting regions where text is present or recognized. The detection map helps focus only on regions where text is present or recognized.

The feature maps from the detection head 506 are also input into the CNN network 510, which estimates both character set identification 512 and print type classification 514. The CNN network 510 is responsible for predicting the character set and print type for each detected text region.

During training of the CNN network 510, the CNN network 510 uses an L1 Norm loss function, taking into account the text detection loss at a pixel level, character set identification, and print type classification. The detection map helps focus only on regions where text is present or recognized. Following is an example of a loss function, which shows that the loss (L) is a combination of the text detection loss (Ltd), the character set identification (Lc), and print type classification (Lp):

$$L = {L}_{td} + λ ( {L}_{c} + {L}_{p} )$$

$$where :$$

$${L}_{td} = {‖ {D}_{td} ( pix ) - {D}_{td}^{*} ( pix ) ‖}^{2}$$

$${L}_{c} = {D}_{td}^{*} ( pix ) \cdot {‖ {D}_{c} ( pix ) - {D}_{c}^{*} ( pix ) ‖}^{2}$$

$${L}_{p} = {D}_{td}^{*} ( pix ) \cdot {‖ {D}_{p} ( pix ) - {D}_{p}^{*} ( pix ) ‖}^{2}$$

Other loss functions could also be used, as one skilled in the art would understand. Generally, the loss (i.e., objection function) represents a measure of the difference between the output predicted by the CNN network and the true target (i.e., results in the training data). The loss function quantifies how well the model is performing on a particular task, and the goal during training is to minimize this loss. The training process includes adjusting parameters to minimize the loss function, as one skilled in the art would understand. In some embodiments, loss can be calculated at the end of each Iteration. The overall loss is weighted with a lambda parameter to control the loss propagation of character-set and print type classification, allowing for fine-tuning the balance between these tasks during training.

During the inference process (i.e., the phase where a trained model is deployed to make predictions or perform tasks on new, unseen data), the text detection map is used to extract text regions, and character set identification and print type classification are performed at each character level within these regions. This ensures that character set and print type information is extracted only from regions where text is detected.

One advantage of the architecture described above relates to model fine-tuning. Model fine-tuning can be performed for individual outputs by freezing specific layers of the architecture. This allows for fine-tuning the model's performance on character set identification, print type classification, or text detection independently, if needed. For example, if a designer wants to fine tune the model with respect to character set identification, layers relating to print type classification (or other aspects) can be frozen, so that they are not affected the fine tuning of the layers associated with character set identification. Also note that, fine-tuning single network is faster compared to fine-tuning multiple individual networks (e.g., such as the case with the architecture of FIGS. 1-4) as the training data collection, data preparation and training time will be different for different networks.

Another advantage of the disclosed systems and methods relates to performance of system and to the components of the system (e.g., computers, networks, memories, modules, neural networks, etc.). By implementing the architecture and techniques of FIG. 5, the inference time is reduced, as the outputs are obtained from a single network. In contrast, with conventional architecture, the original image (input data) passes through 4 or more stages (e.g., text detection, rectification module, character set identification network, print type classification network, etc.). As a result, systems utilizing the disclosed architecture operate more efficiently, faster, and using less resources (e.g., power, data storage, processing power, etc.). The disclosed systems help overcome the technical problem of ever increasing efficiency, processing requirements, resource requirements, etc.

Another advantage of the disclosed systems and methods results from the current character-set and print type identification working at a word level instead of the whole image level, which consumes a lot of memory for loading the models, preprocessing, and post processing steps. Another advantage of the disclosed systems and methods is that the system can work without a rectification module, since character set identification and print type classification can be determined at a character level, versus a word or line level.

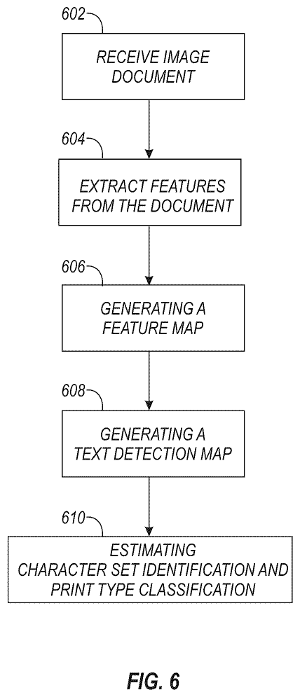

FIG. 6 is a flow chart illustrating an embodiment of a process for text analysis using the architecture shown in FIG. 5. At step 602, an image document(s) is received by a backbone network, which serves as a feature extractor. At step 604, the backbone network extracts features from the input document to capture relevant information for subsequent tasks. At step 606, a detection head, which may include ROI pooling layers for text detection, generates a feature map based on the extracted features. The feature map is provided to both a text detection module and CNN network. At step 608, the text detection component processes the feature map from the detection head to localize text regions within the input images and generates a text detection map highlighting regions where text is present or recognized. The detection map is also provided the CNN network. At step 610, the CNN network 510 estimates both character set identification and print type classification, based on the feature map and the text detection map. The character set identification and print type classification can be used for any desired purpose, for example for use in OCR.

Although the invention has been described with respect to specific embodiments thereof, these embodiments are merely illustrative, and not restrictive of the invention as a whole. Rather, the description is intended to describe illustrative embodiments, features, and functions in order to provide a person of ordinary skill in the art context to understand the invention without limiting the invention to any particularly described embodiment, feature, or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical, or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present), and B is false (or not present), A is false (or not present), and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally, then, although the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature, or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method of text analysis, comprising:
receiving an image document containing textual information;
extracting, by a backbone network, features of the image document;
generating, by a detection head, a feature map based on the extracted features;
generating, by a text detection module from the generated feature map, a text detection map identifying localized text regions in the image document; and
estimating, by a convolutional neural network (CNN) based on the feature map and the text detection map, character set identification and print type classification of text on the image document.

2. The method of claim 1, wherein the backbone network is a ResNet-based backbone network.

3. The method of claim 1, wherein the detection head includes region of interest (ROI) pooling layers for text detection.

4. The method of claim 1, wherein the CNN network is trained based on an L1 Norm loss function.

5. The method of claim 1, wherein the CNN network is trained based on a loss function that is based on a combination of a text detection loss, the estimated character set identification, and the estimated print type classification.

6. The method of claim 5, further comprising fine tuning the CNN network.

7. The method of claim 5, further comprising fine tuning an individual output of the CNN network by freezing one or more layers of the CNN network during a fine-tuning process.

8. A system for text analysis, the system comprising:
a processor; and
a non-transitory computer readable medium storing instructions translatable by the processor, the instructions when translated by the processor perform:
receiving an image document containing textual information;
extracting, by a backbone network, features of the image document;
generating, by a detection head, a feature map based on the extracted features;
generating, by a text detection module from the generated feature map, a text detection map identifying localized text regions in the image document; and
estimating, by a convolutional neural network (CNN) based on the feature map and the text detection map, character set identification and print type classification of text on the image document.

9. The system of claim 8, wherein the backbone network is a ResNet-based backbone network.

10. The system of claim 8, wherein the detection head includes region of interest (ROI) pooling layers for text detection.

11. The system of claim 8, wherein the CNN network is trained based on an L1 Norm loss function.

12. The system of claim 8, wherein the CNN network is trained based on a loss function that is based on a combination of a text detection loss, the estimated character set identification, and the estimated print type classification.

13. The method of claim 12, further comprising fine tuning the CNN network.

14. The method of claim 12, further comprising fine tuning an individual output of the CNN network by freezing one or more layers of the CNN network during a fine-tuning process.

15. A computer program product comprising a non-transitory computer readable medium storing instructions translatable by a processor, the instructions when translated by the processor perform:
receiving an image document containing textual information;
extracting, by a backbone network, features of the image document;
generating, by a detection head, a feature map based on the extracted features;
generating, by a text detection module from the generated feature map, a text detection map identifying localized text regions in the image document; and
estimating, by a convolutional neural network (CNN) based on the feature map and the text detection map, character set identification and print type classification of text on the image document.

16. The computer program product of claim 15, wherein the backbone network is a ResNet-based backbone network.

17. The computer program product of claim 15, wherein the detection head includes region of interest (ROI) pooling layers for text detection.

18. The computer program product of claim 15, wherein the CNN network is trained based on a loss function that is based on a combination of a text detection loss, the estimated character set identification, and the estimated print type classification.

19. The computer program product of claim 18, further comprising fine tuning the CNN network.

20. The computer program product of claim 18, further comprising fine tuning an individual output of the CNN network by freezing one or more layers of the CNN network during a fine-tuning process.
